(19) United States
(12) Patent Application Publication
(10) Pub. No.: US 2001/0006428 A1
(43) Pub. Date: Jul. 5, 2001

(54) Optical space transmission device

(76) Inventor: Hiroshi Mizuno, Tenri-shi (JP)

Correspondence Address: BIRCH, STEWART, KOLASCH & BIRCH, LLP, P.O. Box 747, Falls Church, VA, 22040-0747, US

(21) Appl. No.: 09/742,088

(22) Filed: Dec. 22, 2000

(30) Foreign Application Priority Data
Dec. 22, 1999 (JP) 11-365437

(51) Int. Cl. H04B 10/00

(52) U.S. Cl. 359/172; 359/110

(57) ABSTRACT

An optical space transmission device as a peripheral device includes a communication controller for adjusting a luminous intensity of an LED subsequent to a polling sequence by a host device. Before a communication is established, a luminous intensity is set to be maximum, and as long as a command of a predetermined content is returned from the host device in response to data transmitted from the peripheral device, the luminous intensity of the LED is reduced by one level. On the other hand, upon detecting a receiving error of the command by a receiving error detecting circuit, the luminous intensity of the LED is increased by one level, thereby determining an optimal luminous intensity.

### FIELD OF THE INVENTION

The present invention generally relates to an optical space transmission device for carrying out a bi-directional optical infrared communication between a host device and peripheral devices, and particularly relates to an optical space transmission device which enables a reduction in power consumption in communicating.

### BACKGROUND OF THE INVENTION

Bi-directional data communication between a personal computer and peripheral devices using infrared ray has been standardized by IrDA (Infrared Data Association), and recent years have seen increasing demand for optical space transmission devices of this standard in a variety of applications. Moreover, for this standard of IrDA, an IrDA control designed for a longer distance transmission has been standardized. For the above long distance transmission system, a development of new communication system for AV devices and household electric appliances, and a cordless transmission among peripheral devices such as a personal computer, a mouse, a keyboard, a joy stick, etc., can be expected.

The IrDA control is a system for a half duplex communication to be performed by an optical space transmission device for one to plural communications. This IrDA control is adopted, for example, for a communication between a personal computer serving as a host computer, and peripheral devices such as mouses, keyboards, joy sticks, etc. To realize a long distance transmission of not less than 5 m, a transmission of ASK (amplitude shift keying) system is performed for super imposing an auxiliary transmission wave of 1.5 MHz to a signal of a transmission speed of 75 kbps as shown by a transmission waveform of FIG. 5.

A modulation system is a 16 PSM (Pulse Sequence Modulation) system, in which binary signals “0” and “1” are transmitted and received, and a transmission signal is outputted at a timing of a pulse “1”. As shown in FIG. 5, this transmission signal is composed of AGC, PRE, STA, MAC frame, CRC and STO. In the 16 PSM system, transmitting and receiving are performed by inputting a signal of 16 PSM code into the MAC frame.

An optical space transmission device serving as a host computer is arranged such that a transmission use emitting device (LED), a receiving use light receiving device (PD: photodiode) and a signal processing IC are provided in one integral part. This host device is provided with a plurality of auxiliary light emitting devices (LED) around the light emitting device and a wider angle transmission is permitted so as to enable the host device to communicate with a plurality of peripheral devices.

An example of the optical space transmission device serving as the peripheral device is shown in FIG. 7. As shown in FIG. 7, an optical space transmission device 51 includes a CPU 52, a ROM 53, a RAM 54, a communication controller 55, and a front end (F/E) section 56. When the CPU 52 executes a command according to the order recorded in the ROM 53, the data in the RAM 54 are transferred to the communication controller 55. Further, based on this data, a modulated signal Tx is transferred from the communication controller 55 to the F/E section 56. When receiving, a receiving signal Vo is transmitted from the F/E section 57 to the communication controller 55.

An example structure of the F/E section 56 is shown in FIG. 8. When transmitting, the F/E section 56 controls ON/OFF of a transistor in a drive section 58 according a modulated signal Tx supplied from a modulating circuit in the transmission controller 55 through the RC circuit 57, and light is emitted from a light emitting diode (LED) 59 by drive current determined by the limit resistance R_{L} in the ON state. In the ON state of the transistor, the LED 59 emits light by drive current determined by a control resistance R_{L}. When receiving, the electric signal as received from a photodiode (PD) 60 is processed by a receiving section IC 61 composed of an amplifier 61a, a band pass filter 61b and a Schmitt gate 61c. The resulting receiving signal is outputted to the demodulating circuit of the second state as a receiving signal Vo. The peripheral device is, for example, a mouse, a keyboard, a joy stick, a remote controller, etc., and thus a communication with the host device is performed at a short distance or a long distance depending on the peripheral device. When performing transmitting and receiving between the host device and a plurality of peripheral devices simultaneously, the host device polls the plural peripheral devices to realize communication therewith. Then, upon establishing communication, the transmitting and receiving of data are started between the host device and each peripheral device.

In the conventional optical space transmission device, irrespectively of varying distance between the host device and each peripheral device, a luminous intensity of the light emitting device (LED 59) of each peripheral device is constant. Namely, the luminous intensity of the light emitting device is proportional to the drive current of the light emitting device. However, irrespectively of a peripheral device for a short distance communication and a peripheral device for a long distance communication, the limit resistance R_{L} shown in FIG. 8 is constant, and thus the luminous intensity is constant. Moreover, the drive current of the light emitting device is set larger than required so as to enable long distance communication.

It therefore means that in a transmission of a short distance communication, most of driving power is wasted by performing a transmission at a higher luminous intensity than required. Furthermore, this wasting of power in the transmission for a short distance communication results in a shorter life of battery used in driving the foregoing peripheral devices.

Conventionally, attempts have been made to reduce power consumption in short distance communication. For example, Japanese Unexamined Patent Publication No. 69817/1997 (Tokukaihei 9-69817, published on Mar. 11, 1997) discloses a structure of reducing power consumption wherein in the case of performing optical communication between two transmitting and receiving devices, in response to data transmitted from the first transmitting and receiving device, the second transmitting and receiving device returns the information indicative of a receiving light intensity to the first transmitting and receiving device, and the first transmitting and receiving device adjusts the luminous intensity based on the information indicative of receiving light intensity as received, thereby determining minimum luminous intensity required for the communication distance.

Another structure of reducing power consumption is disclosed by Japanese Unexamined Patent Publication No. 66780/1995 (Tokukaihei 7-66780, published on Mar. 10, 1995), wherein in order to perform an optical communication between the two communication devices, depending on whether or not a response message in response to a message from one communication device is received by the associated communication device, the luminous intensity of the former communication device adjusts the luminous intensity a level by a level, so as to suppress an excessive output of the light emitting device.

Japanese Unexamined Patent Publication No. 252853/1994 (Tokukaihei 6-252853, published on Sep. 9, 1994) discloses a still another structure of reducing power consumption in optical communication between a local office and an associated office by determining a level of an optical signal from the associated office, and optimizing an output level of an optical signal of the local office for the level as determined.

The foregoing adjusting mechanism of the luminous intensity of the above publication is not designed for one to plural communication but for one to one optical communication. For example, the above publication of Japanese Unexamined Patent Publication No. 69817/1997 discloses an optimization of a transmission output, i.e., a luminous intensity, to a transmitting and receiving device closest to the transmission and receiving device. However, an optimization of a transmission output for communication with a further transmission and receiving device is based on a provision that a communication with a closer transmission and receiving device is not performed in order to prevent communication disturbances. This means that for communication between a transmission and receiving device serving as a host device and other transmission and receiving devices serving as peripheral devices, respective optimal transmission outputs do not differ from a combination of optimal transmission outputs in one to one communications. Therefore, in order to realize communications between one host device with a plurality of transmission and receiving devices without interference, transmitting and receiving sections in the same number of transmitting and receiving devices as that provided in the associated device would be required as required in the one to one communications.

### SUMMARY OF THE INVENTION

It is an object of the present invention to provide an optical space transmission device which permits a reduction in power consumption by adjusting luminous intensity of a light emitting element according to communication distance.

In order to achieve the above object, the optical space transmission device for one to plural bi-directional optical communications is characterized by including:

transmission result detection means for determining, subsequent to a polling sequence, if a transmission to an associated office is performed successfully by detecting if a command of a predetermined content is returned from the associated office in response to data transmitted thereto at a predetermined luminous intensity; and

luminous intensity adjusting means for adjusting a subsequent luminous intensity based on a result of detection by the transmission result detection means.

According to the above structure of the present invention, in one to plural bi-directional optical communications, subsequent to the polling sequence to be performed by the host device, i.e., a communication establishing sequence between the host device and the plural peripheral devices, the transmission result detection means (receiving error detecting circuit) determines if transmission to the associated office is performed successfully, and the luminous intensity is adjusted by the luminous intensity adjusting means (communication controller) based on the result of detection by the transmission result detection means. Additionally, the above determination if the transmission is performed successfully can be made by detecting if a command of a predetermined content is transmitted from the associated office in response to the data transmitted thereto at a predetermined luminous intensity.

The host device inquires each peripheral device to confirm peripheral devices be communicated with in polling, and communication is established by arranging all the peripheral devices which desire for communication in order so that the host device can communicate with the peripheral devices simultaneously and independently. Accordingly, by adjusting the luminous intensity while carrying out polling, with respect to all the peripheral devices to be communicated with simultaneously, respective minimum required luminous intensities for communication can be determined according to communication distances. The described structure of adjusting the luminous intensity can be applied also to the host device. Moreover, the transmission result can be determined merely by detecting if a command of a predetermined content is received, thereby permitting the transmission result detection means to be controlled with ease.

The foregoing one to plural bi-directional optical communication system which adjusts the luminous intensity of the luminous device according to a communication distance offers an optical space transmission device which enables a reduction in power consumption.

In the above arrangement, it is preferable that the transmission result detection means determines if the command is returned based on a ratio of receiving error of the command.

In the above structure, determination if a command is received is made based on the receiving error rate. Therefore, the determination can be made by the generally used method of, for example, detecting if the number of error pulses of the receiving signal is within the bit error rate or if a wait time for the return command is over.

In the above arrangement, it is also preferable that the luminous intensity adjusting means is capable of adjusting the luminous intensity a plurality of levels in such a manner that a luminous intensity is maximized when starting transmission, and as long as the transmission result detection means determines that the transmission is performed successfully, the luminous intensity is reduced by one level, while if the transmission result detection means determines that the transmission is not performed successfully, the luminous intensity is increased by one level, thereby determining a minimum required luminous intensity.

According to the above structure, from the maximum luminous intensity at which a transmission to the associated office is started, the luminous intensity is reduced a level by a level as long as the transmission is determined to be performed successfully, and the luminous intensity one level above the luminous intensity at which a transmission error is detected for the first time is determined to be an optimal luminous intensity. Therefore, an optimal luminous intensity can be determined with accuracy. Moreover, the luminous intensity can be adjusted continuously after performing polling at the maximum luminous intensity at which communication can be surely established.

In the above arrangement, it is also preferable that the luminous intensity adjusting means adjusts the luminous intensity by increasing and decreasing a drive current of a light emitting element.

According to the above structure, by increasing or decreasing the drive current of the light emitting device, the luminous intensity can be adjusted, and thus the luminous intensity adjusting means of a simple structure of merely selecting a circuit to be connected to the light emitting element can be achieved.

In the foregoing arrangement, it is preferable that only in its application to a peripheral device with respect to the host device for the optical transmission, the transmission result detection means and the luminous intensity adjusting means are provided.

According to the optical space transmission device of the above structure, the luminous intensity is adjusted only in its application to the peripheral device. Therefore, for the battery driven peripheral device, the battery can last longer, and the structure of the host device to which power is supplied from a commercial use power supply can be simplified.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a circuit block diagram showing a structure of an optical space transmission device in accordance with one embodiment of the present invention.

FIG. 2 is an explanatory view showing a communication relationship between a host device and an optical space transmission device as a peripheral of FIG. 1.

FIG. 3 is an explanatory view showing data transmitting and receiving process of data between the post device and the peripheral device.

FIG. 4 is a graph showing a relationship a result of detection of a receiving error and a luminous intensity.

FIG. 5 is a waveform diagram illustrating one example of a transmission waveform for use in IrDA control.

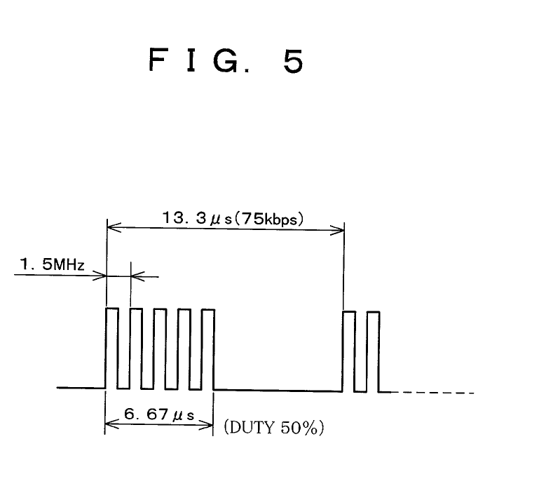

FIG. 6 is an explanatory view showing one example of a frame format for use in IrDA control.

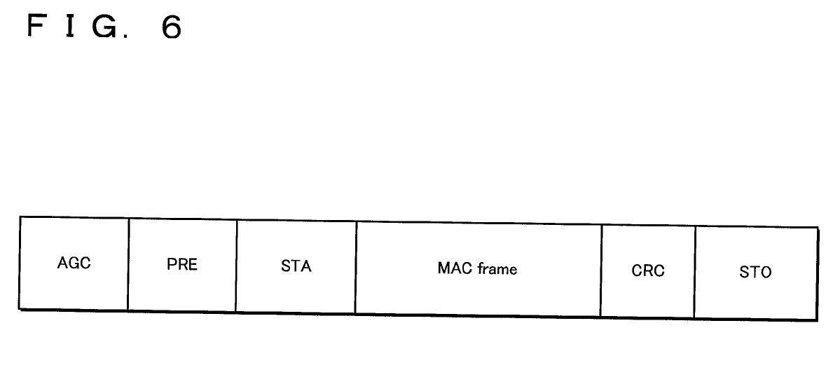

FIG. 7 is a block diagram showing a conventional structure of an optical space transmission device.

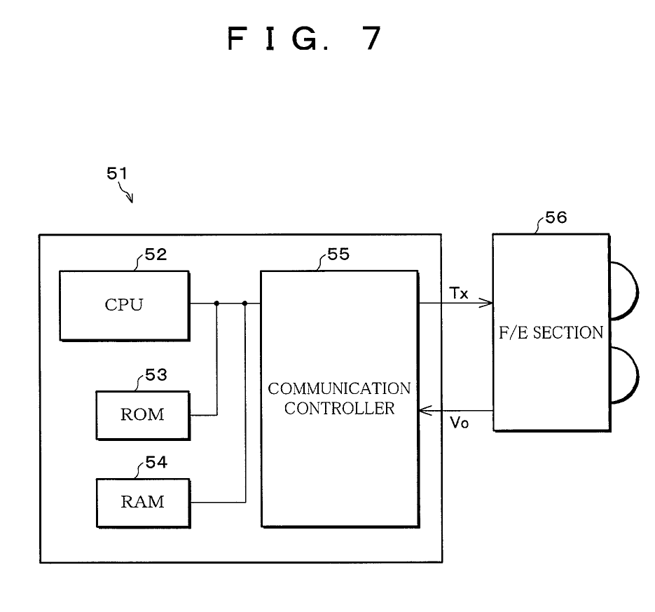

FIG. 8 is a circuit block diagram showing a structure of a front end portion of the optical space transmission device of FIG. 7.

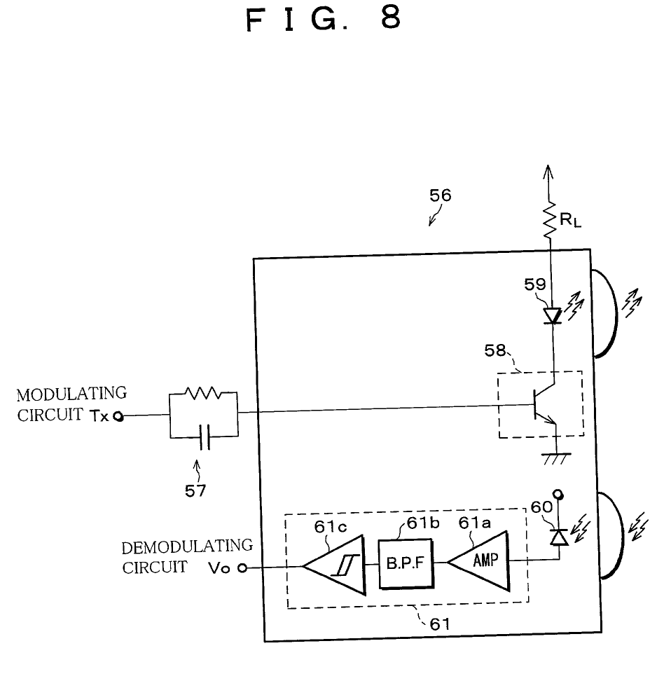

### DESCRIPTION OF THE EMBODIMENTS

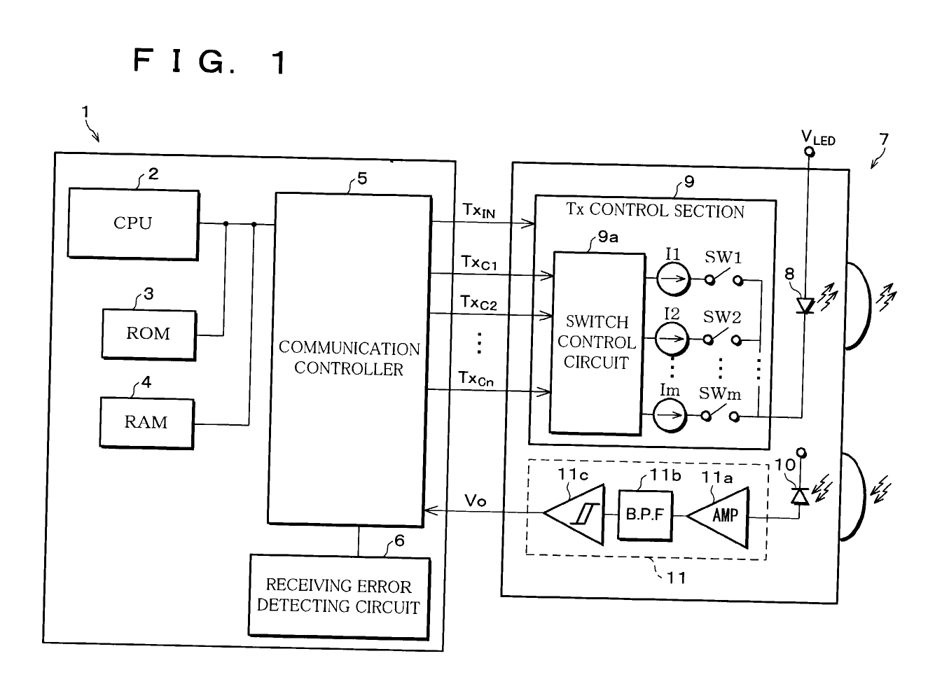

The following description will discuss one embodiment of the present invention in reference to FIGS. 1 to 4.

FIG. 1 shows a structure of an optical space transmission device 1 in accordance with the present embodiment. This optical space transmission device 1 permits one to plural bi-directional optical communication to be performed independently, for example, by the IrDA (Infrared Data Association) control. The optical space transmission device 1 is applicable to both the host device and peripheral device. Hereinafter, an explanation will be given through the case of adopting the optical space transmission device 1 as a peripheral device such as a mouse, a keyboard, a joy stick, a remote controller or the like.

As shown in the Figure, the optical space transmission device 1 includes a CPU 2, a ROM 3, a RAM 4, a communication controller 5, a receiving error detecting circuit 6 and a front end section (F/E section) 7. The CPU 2 executes a command in the order of transmitting and receiving as recorded in the ROM 3, and transfers transmission data stored in the RAM 4 to the communication controller 5. On the other hand, the CPU 2 stores the data as received from the communication controller 5 in the RAM 4. The communication controller 5 generates a predetermined modulation signal Tₓᵢₙ by the modulation circuit using transmission data as transferred from the RAM 4, and is outputted to the peripheral device. The communication controller 5 outputs control signals Tx_{c1}, Tx_{c2}, . . . , Tx_{cn} to the switch control circuit 9a. When receiving, the receiving signal Vo from the F/E section 7 is demodulated by the demodulating circuit to obtain data as received.

The receiving error detecting circuit 6 serves as transmission result detection means of the present invention. The receiving error detecting circuit 6 detects a receiving error by determining if an error in the receiving data from the communication controller 5 is within an error bit rate, or determining if data in response to a transmission is received within a predetermined time is determined. Then, the receiving error detecting circuit 6 outputs a resulting detection signal to the communication controller 5.

The F/E section 7 includes a transmitting section composed of a light emitting diode (LED) 8, and a Tx control section 9, and a receiving section composed of a photodiode (PD) 10 and an IC receiving section 11. In the transmitting section, the LED 8 is arranged so as to connect an anode to the power source voltage V_{LED}, and a cathode to an output terminal of the Tx control section 9. The Tx control section 9 includes a switch control circuit 9a, fixed current circuits I1, I2, . . . , Im, and switches SW1, SW2, . . . , SWm. The Tx control section 9 functions as luminous intensity adjusting means as a communication controller 5.

In the switch control section 9a, control signals Tx_{c1}, Tx_{c2}, . . . and Tx_{cn} are inputted as data of n bits. The switch control section 9a controls ON/OFF of switches SW1, SW2, . . . and SWm corresponding to the data, and vary current into 2ⁿ stages by combinations of fixed current circuits I1, I2, . . . , and Im. As a result, an amplitude of a modulated signal Tx_{IN} from the communication controller 5 is varied, and a luminous intensity of the LED 8 is varied 2ⁿ levels.

In the receiving section, the PD 10 receives an optical signal from the host device and converts it into an electric signal to be sent to the receiving section IC 11. The receiving section IC11 includes an amplifier 11a for amplifying an electric signal from the PD 10, and a band pass filter 11b for taking a predetermined frequency band of an amplified signal, and a Schmitt gate 11c for shaping a waveform of an output of the band pass filter 11b. The signal as processed by the receiving section IC 11 is outputted to the communication controller 5 as a receiving signal Vo.

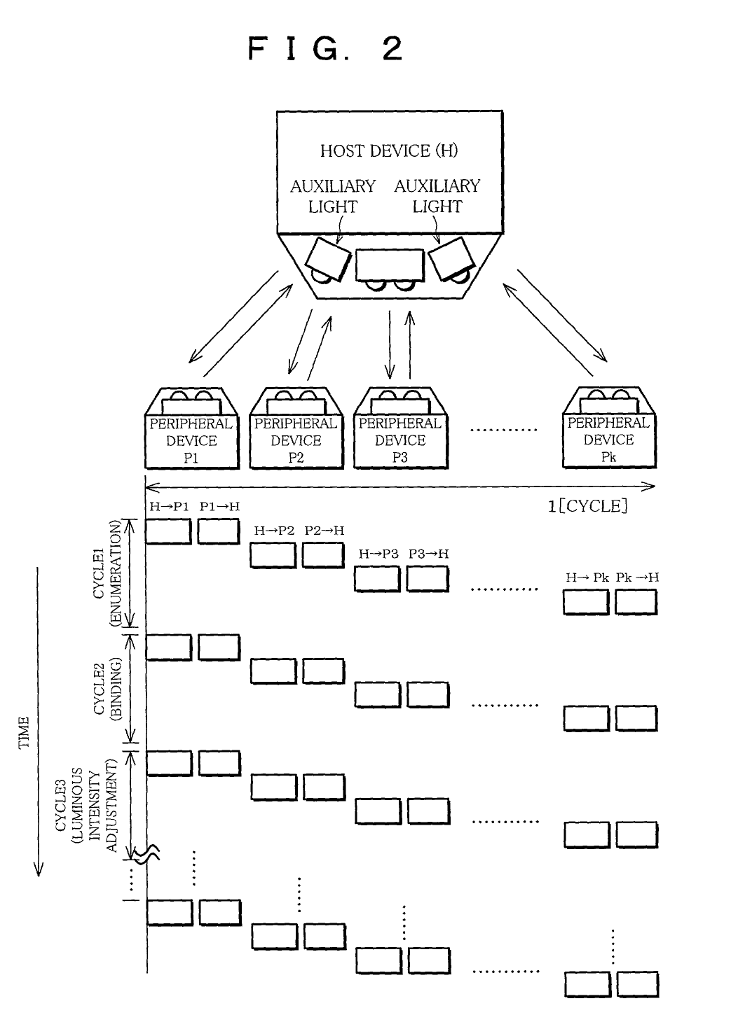

Next, the method of optimizing the luminous intensity of the LED 8 using the optical space transmission device 1 of the described arrangement will be explained. FIG. 2 shows a relationship between the host device and plural peripheral devices (k peripheral devices: k is an integer of not less than two). The host device is provided with subsidiary LEDs around the main light emitting and receiving section composed of the LED and the PD so as to enable communication with the peripheral device at wide angle. In the case where the host computer performs a communication with k peripheral devices P1, P2, . . . and Pk, a polling is performed at intervals of several tens msec by the host device to each peripheral device. In polling, as shown in the Figure, a host device inquires each peripheral device at initial cycle to recognize peripheral devices to be communicated with in enumeration. Then, a binding is performed in the next cycle by numbering respective peripheral devices in order.

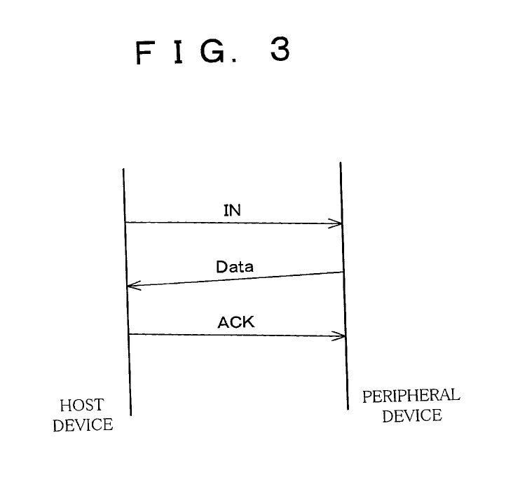

In the subsequent cycle, transmission and receiving of data to be performed sequentially, and in this state, as shown in FIG. 3, a host device transmits an IN command to each peripheral device. The peripheral device which recognizes the IN command transmits data (Data) to the host device. Then, the host device transmits an acknowledgement (ACK) command indicative of a receipt of the data to the peripheral device. Upon receipt of the acknowledgement (ACK) command by the peripheral device, a communication can be performed. In the conventional one to plural communication, after the communication is permitted, the following communication is continued. In contrast, according to the structure of the present embodiment, a luminous intensity of the LED 8 of each peripheral device is adjusted subsequent to polling sequence. As described, the receiving error detecting circuit 6 is provided in each peripheral device, and an adjustment of luminous intensity is performed based on the result of detection by the receiving error detecting circuit 6.

The receiving error detecting circuit 6 determines that a receiving error occurs, for example, at the following event. That is, upon detecting that a signal in a frame of the described transmission signal from the peripheral device lacks due to insufficient optical output caused by a long distance communication with the host device, and a command of a predetermined content returned from the corresponding host device is detected to be a receiving error. In the determination of the receiving error, a special method is not required, and for example, the method of comparing the error rate as received with the bit error rate can be adopted.

For example, assumed the bit error rate be ±10⁻⁴, then, if the number of receiving pulses when transmitting 300 thousand pulses from the host device is in a range of from not less than 299970 pulses to not more than 300030 pulses, it is determined a transmission from the peripheral device to the host device is performed successfully. On the other hand, if the number of pulses is not more than 299969 or not less than 300031 pulses, a signal as returned is recognized to be a different command from the command as expected, and thus it is determined that a transmission from the peripheral device to the host device is not performed successfully. As described, the determination on the result of detection by the peripheral device can be performed by detecting whether or not a command of a predetermined content is received. As a result, the receiving error detecting circuit 6 can be controlled with ease.

Before communication is established, the switch control circuit 9a of the peripheral device controls all the switches SW1, SW2, . . . SWm to be closed. Therefore, in the LED 8, a sum current flows in the fixed current circuits 11, 12, . . . and Im, and a luminous intensity is maximized. At this maximum luminous intensity, a communication is performed at a standard distance, and a communication from the peripheral device to the host device can be performed successfully unless there exist any obstacle. In order to permit communication with any peripheral device located within a predetermined distance from the host device, a transmission is always performed at the maximum luminous intensity. In this way, as long as a transmission from the peripheral device to the host device successes, the command of a predetermined content can be returned from the host device for sure, and a receiving error can be prevented.

Upon receiving a command of a predetermined content from the host device, it is determined if a receiving error occurs by the receiving error detecting circuit 6. Then, a detection signal is inputted to the communication controller 5. Upon receiving a detection signal indicative of whether or not a receiving error exists, the communication controller 5 varies control signals Txc1, Txc2, . . . , and Txcn, and releases any one of the switches SW1, SW2, . . . , and SWm. Then, the communication controller 5 reduces the luminous intensity by one level by reducing the drive current of the LED 8.

For example, when n= 2, four ways of closing the switches SW1, SW2, . . . , and SWm by 2 bit data composed of control signals TX_{c1} and TX_{c2} exist. As shown in Table 1, the luminous intensity of the LED 8 can be classified into four levels from the Mode 1 to the Mode 4.

TABLE 1

| | | | Luminous | Relative |
|---|---|---|---|---|
| Mode | Txc1 | Txc2 | Intensity | Distance |
| Mode 1 | 0 | 0 | 1 | 100% |
| Mode 2 | 0 | 1 | ½ | 70% |
| Mode 3 | 1 | 0 | ¼ | 50% |
| Mode 4 | 1 | 1 | ⅛ | 35% |

In this case, it is assumed the luminous intensity of the LED 8 is maximized in the Mode 1, then, the luminous intensity is reduced to ½, ¼, and ⅛ as the mode changes from the mode 2, the mode 3 and the mode 4. The relative distance which permits communication is in proportional to a square root of luminous intensity as shown in Table 1, and, for example, in the Mode 4 where the luminous intensity is ⅛ of the maximum luminous intensity, the relative distance which permit communication is 35 percent of the maximum luminous intensity.

According to this table, the communication controller 5 sets the luminous intensity to Mode 1 where Tx_{c1}=0, Tx_{c2}=0 until a first detection signal indicative of no detection error is received. Upon receiving the detection signal indicative of no receiving error, the communication controller 5 sets the luminous intensity to Mode 2, which is one level below the initial Mode 1 where Tx_{c1}=0, Tx_{c2}=0. Then, in Mode 2, transmission to the host device is performed again, and a command receiving state from the host device is determined. As described, as long as the peripheral device receives a command indicating that the host device recognizes a transmission from the peripheral device, the luminous intensity of the LED 8 from the peripheral device is reduced a level by a level.

Then, for example, when the receiving error detection section 6 determines the command from the host device in response to a transmission by the peripheral device in Mode 4 is an error for the first time, the communication controller 5 changes the control signal from Tx_{c1}=1, Tx_{c2}=1, to Tx_{c1}=1, Tx_{c2}=0 so as to increase the luminous intensity of the LED by one level. Therefore, the minimum luminous intensity required for the above communication distance is determined to be Mode 3.

By the foregoing level by level adjustment of the luminous intensity, an optimal luminous intensity of the LED 8 can be determined with accuracy. Moreover, after polling at the maximum luminous intensity at which communication can be surely established, the luminous intensity can be adjusted continuously. Additionally, since the luminous intensity is adjusted by increasing or decreasing the drive current of the LED 8, the luminous intensity adjusting means of a simple structure of merely selecting the fixed current circuit to be connected to the LED 8 can be achieved.

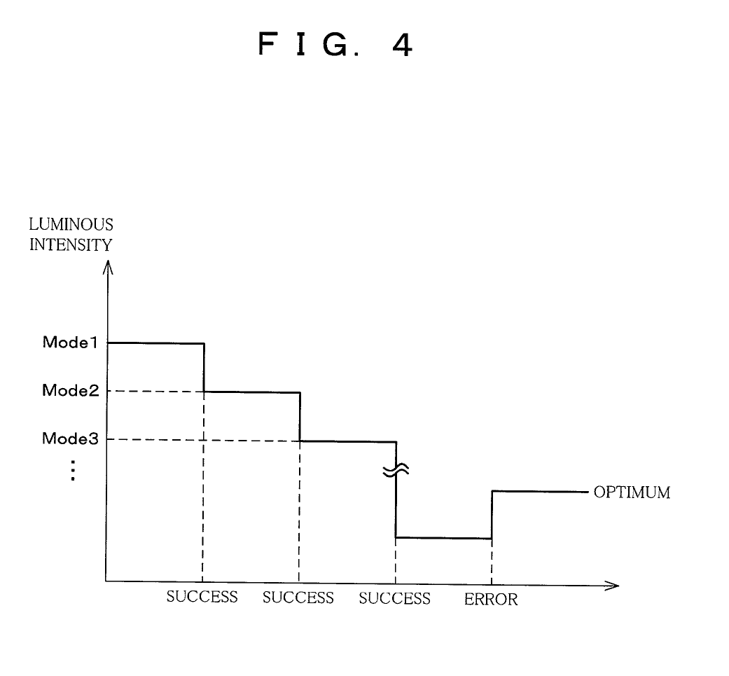

In general, the same can be applied to the case where n bit data composed of control signals Tx_{c1}, Tx_{c2}, . . . and Tx_{cn} are inputted to the switch control circuit 9a. Then, assumed that as shown in FIG. 4, the luminous intensity of the LED 8 is reduced a level by a level as long as transmission is determined to be performed successively. On the other hand, upon detecting the receiving error for the first time, the luminous intensity of the LED 8 is increased by one level. In this case, the switch control section 9a can realize 2ⁿ combinations for closing the switches SW1, SW2, . . . and SWm, and the drive current of the LED 8 is varied 2ⁿ levels. The drive current are, for example, reduced to ½→¼→⅛→ . . . of the maximum current, however, the manner of setting the drive current is not particularly limited. Further, as the luminous intensity of the LED 8 is in proportion to the drive current, the luminous intensity is also reduced to ½→¼→⅛→ . . . of the maximum luminous intensity.

As described, according to the optical space transmission device 1 of the present embodiment, in the one to plural optical communications, subsequent to polling sequence to be performed by the host device, i.e., a communication establishing sequence between the host device and plural peripheral devices, it is determined by the receiving error detecting circuit 6 if a transmission to the host device is performed successfully. Based on the result of this detection, the communication controller 5 and the Tx control section 9 adjust the luminous intensity of the LED 8. The detection if the transmission is performed successively is made by detecting if a command of a predetermined content is returned from the host device in response to a transmission at a predetermined luminous intensity.

As described, by adjusting the luminous intensity of the LED 8 subsequent to the polling sequence to be performed by the host device, the minimum required luminous intensity for the communication can be determined according to the communication distance with respect to all the peripheral devices to be communicated with simultaneously. In the above example, the optical space transmission device 1 is provided for adjusting the luminous intensity when adopting it as a peripheral device. Thus, the life of the battery use peripheral device can be made longer, and the structure of the host device to which power is supplied by the commercial use power supply can be simplified. Additionally, for the host computer, the structure of adjusting the luminous intensity can be adopted for the commercial use power supply.

As described, according to the optical space transmission device 1 in accordance with the present invention, in the one to plural bi-directional optical communication system, the luminous intensity of the luminous distance can adjusted according to the communication distance, thereby permitting a reduction in power consumption in communicating.

As described, the first optical space transmission device of the present invention which permits one to plural bi-directional optical communications includes transmission result detection means for determining subsequent to a polling sequence if a transmission to an associated office is performed successfully by detecting if a command of a predetermined content is returned from the associated office in response to data transmitted thereto at a predetermined luminous intensity; and

luminous intensity adjusting means for adjusting a subsequent luminous intensity based on a result of detection by the transmission result detection means.

According to the above structure of the present invention, in one to plural bi-directional optical communications, subsequent to the polling sequence to be performed by the host device, i.e., a communication establishing sequence between the host device and the plural peripheral devices, the transmission result detection means (receiving error detecting circuit) determines if transmission to the associated office is performed successfully, and the luminous intensity is adjusted by the luminous intensity adjusting means (communication controller) based on the result of detection by the transmission result detection means. Additionally, the above determination if the transmission is performed successfully can be made by detecting if a command of a predetermined content is transmitted from the associated office in response to the data transmitted thereto at a predetermined luminous intensity.

In polling, each peripheral device to be communicated with is confirmed by inquiring, and communication is established by arranging all the peripheral devices which desire for communication in order so that the host device can communicate with the peripheral devices simultaneously and independently. Accordingly, by adjusting the luminous intensity while carrying out polling, with respect to all the peripheral devices to be communicated with simultaneously, respective minimum required luminous intensities required for communication can be determined according to communication distances. The described structure of adjusting luminous intensity can be applied also to the host device. Moreover, the transmission result can be determined merely by detecting if a command of a predetermined content is received, thereby permitting the transmission result detection means to be controlled with ease.

The foregoing one to plural bi-directional optical communication system which adjusts the luminous intensity of the luminous device according to a communication distance offers an optical space transmission device which enables a reduction in power consumption.

The second optical space transmission device of the present invention having the structure of the first space transmission device is characterized in that:

the transmission result detection means determines if the command is returned based on a ratio of receiving error of the command.

In the above structure, determination if a command is received is made based on the receiving error rate. Therefore, the determination can be made by the generally used method of, for example, detecting if the number of error pulses of the receiving signal is within the bit error rate or if a wait time for the return command is over.

The third optical space transmission device of the present invention having the structure of the first or second optical space transmission device is characterized in that:

the luminous intensity adjusting means is capable of adjusting the luminous intensity a plurality of levels in such a manner that a luminous intensity is maximized when starting transmission, and as long as the transmission result detection means determines that the transmission is performed successfully, the luminous intensity is reduced by one level, while if the transmission result detection means determines that the transmission is not performed successfully, the luminous intensity is increased by one level, thereby determining a minimum required luminous intensity.

According to the above structure, from the maximum luminous intensity at which a transmission to the associated office is started, the luminous intensity is reduced a level by a level as long as the transmission is determined to be performed successfully, and the luminous intensity one level above the luminous intensity at which a transmission error is detected for the first time is determined to be an optimal luminous intensity. Therefore, an optimal luminous intensity can be determined with accuracy. Moreover, the luminous intensity can be adjusted continuously after performing polling at the maximum luminous intensity at which communication can be surely established.

The fourth optical space transmission device of the present invention having the structure of any of the first through third optical space transmission device is characterized in that the luminous intensity adjusting means adjusts the luminous intensity by increasing and decreasing a drive current of a light emitting element.

According to the above structure, by increasing or decreasing the drive current of the light emitting device, the luminous intensity can be adjusted, and thus the luminous intensity adjusting means of a simple structure of merely selecting a circuit to be connected to the light emitting element can be achieved.

The fifth optical space transmission device of the present invention having the structure of any of the first through fourth optical space transmission device is characterized in that only in its application to a peripheral device with respect to the host device for the above optical transmission, the transmission result detection means and the luminous intensity adjusting means are provided.

According to the optical space transmission device of the above structure, the luminous intensity is adjusted only in its application to the peripheral device. Therefore, for the battery driven peripheral device, the battery can last longer, and the structure of the host device to which power is supplied from a commercial use power supply can be simplified.

The invention being thus described, it will be obvious that the same may be varied in many ways. Such variations are not to be regarded as a departure from the spirit and scope of the invention, and all such modification as would be obvious to one skilled in the art are intended to be included within the scope of the following claims.

1. An optical space transmission device for one to plural bi-directional optical communications including:
transmission result detection means for determining subsequent to a polling sequence if a transmission to an associated office is performed successfully by detecting if a command of a predetermined content is returned from the associated office in response to data transmitted thereto at a predetermined luminous intensity; and
luminous intensity adjusting means for adjusting a subsequent luminous intensity based on a result of detection by said transmission result detection means.

2. The optical space transmission device as set forth in claim 1, wherein:
said transmission result detection means determines if the command is returned based on a ratio of receiving error of the command.

3. The optical space transmission device as set forth in claim 1, wherein:
said luminous intensity adjusting means is capable of adjusting the luminous intensity at multiple levels in such a manner that a luminous intensity is maximized at a time of starting transmission, and as long as the transmission result detection means detects that a transmission is performed successfully, the luminous intensity is reduced by one level, while if the transmission result detection means detects that a transmission is not performed successfully, the luminous intensity is increased by one level, thereby determining a minimum required luminous intensity.

4. The optical space transmission device as set forth in claim 1, wherein:
the luminous intensity adjusting means adjusts the luminous intensity by increasing or decreasing the drive current of a light emitting element.

5. The optical space transmission device as set forth in claim 1, wherein:
said optical space transmission device can be used both as a host device and a peripheral device.

6. The optical space transmission device as set forth in claim 1, wherein:
only in its application to a peripheral device with respect to a host device for said optical transmission, said transmission result detection means and said luminous intensity adjusting means are provided.
